(19) United States
(12) Patent Application Publication
(10) Pub. No.: US 2014/0377557 A1
(43) Pub. Date: Dec. 25, 2014

(54) FLUORINE-INCLUDING ELASTOMER COMPOSITION, AND INSULATED WIRE AND INSULATED CABLE USING THE SAME

(71) Applicant: HITACHI METALS, LTD., TOKYO (JP)

(72) Inventor: Masanobu NAKAHASHI, Hitachi (JP)

(21) Appl. No.: 14/298,380

(22) Filed: Jun. 6, 2014

(30) Foreign Application Priority Data
Jun. 20, 2013 (JP) 2013-129873

(51) Int. Cl. H01B 3/44; C08L 27/18

(52) U.S. Cl. CPC H01B 3/445; C08L 27/18; H01B 3/441; C08L 2203/202; C08L 2205/025; C08L 2205/03
USPC 428/394; 525/199

(57) ABSTRACT

A fluorine-including elastomer composition includes a fluororesin component including a first fluorine-including copolymer including a tetrafluoroethylene and an α-olefin having a carbon number of 2 to 4 and a second fluorine-including copolymer including an ethylene-tetrafluoroethylene copolymer, a polyethylene resin mixed in an amount of 10 to 50 parts by mass per 100 parts by mass of the fluororesin component, and a crosslinking aid. A mass ratio of the first fluorine-including copolymer to the second fluorine-including copolymer is 90:10 to 10:90.

### BACKGROUND OF THE INVENTION

1. FIELD OF THE INVENTION

The invention relates to a fluorine-including elastomer composition and an insulated wire and an insulated cable using the fluorine-including elastomer composition. In more detail, the invention relates to a fluorine-including elastomer composition that exhibits excellent toughness (tensile strength, elongation, cut-through properties) and processability (no foam or lump generation at the time of extrusion and good appearance after extrusion) when molded into e.g. an insulation layer/sheath of an insulated wire/insulated cable, as well as an insulated wire and an insulated cable using the fluorine-including elastomer composition.

2. DESCRIPTION OF THE RELATED ART

Wires/cables are made by forming an insulation layer/sheath on an outer periphery of a conductor and then crosslinking the insulation layer/sheath and, as an insulating material/sheath material thereof, a copolymer of tetrafluoroethylene and a-olefin having a carbon number of 2 to 4 and an ethylene-tetrafluoroethylene copolymer are used because of its excellence in heat resistance, oil resistance, chemical resistance, electrical insulation properties and flexibility, etc.

The copolymer of tetrafluoroethylene and a-olefin having a carbon number of 2 to 4 has lower mechanical characteristics such as tensile strength than a general fluororesin typified by a tetrafluoroethylene-hexafluoropropylene copolymer and thus has a problem in toughness. Thus, it has been proposed to blend a fluororesin such as ethylene-tetrafluoroethylene copolymer in order to improve toughness of the copolymer of tetrafluoroethylene and a-olefin having a carbon number of 2 to 4 (see e.g. JP-A-H05-078539).

### SUMMARY OF THE INVENTION

Since the fluororesin such as ethylene-tetrafluoroethylene copolymer has a high melting point, temperature during extrusion molding needs to be increased to near 300° C. This may cause a problem that a foam or lump generates upon extrusion.

In addition, a problem may arise that the compound cost increases since expensive fluorine-based materials such as tetrafluoroethylene-propylene copolymer and ethylene-tetrafluoroethylene copolymer are used

It is an object of the invention to provide a fluorine-including elastomer composition that exhibits excellent toughness (tensile strength, elongation, cut-through properties) and processability (no foam or lump generation at the time of extrusion and good appearance after extrusion) when molded into e.g. an insulation layer/sheath of an insulated wire/insulated cable, as well as an insulated wire and an insulated cable using the fluorine-including elastomer composition.
(1) According to one embodiment of the invention, a fluorine-including elastomer composition comprises:
   a fluororesin component comprising a first fluorine-including copolymer comprising a tetrafluoroethylene and an a-olefin having a carbon number of 2 to 4 and a second fluorine-including copolymer comprising an ethylene-tetrafluoroethylene copolymer;
   a polyethylene resin mixed in an amount of 10 to 50 parts by mass per 100 parts by mass of the fluororesin component; and
   a crosslinking aid,
   wherein a mass ratio of the first fluorine-including copolymer to the second fluorine-including copolymer is 90:10 to 10:90.
(2) According to another embodiment of the invention, an insulated wire comprises:
   a conductor; and
   an insulation layer formed on an outer periphery of the conductor by covering the conductor with the fluorine-including elastomer composition according to the embodiment (1) and crosslinking the fluorine-including elastomer composition.
(3) According to another embodiment of the invention, an insulated cable comprises:
   one or more insulated wires each comprising a conductor and an insulation layer; and
   a sheath formed on an outer periphery of the one or more insulated wires by covering the sheath with the fluorine-including elastomer composition according to the embodiment (1) and crosslinking the fluorine-including elastomer composition.

### EFFECTS OF THE INVENTION

According to one embodiment of the invention, a fluorine-including elastomer composition can be provided that exhibits excellent toughness (tensile strength, elongation, cut-through properties) and processability (no foam or lump generation at the time of extrusion and good appearance after extrusion) when molded into e.g. an insulation layer/sheath of an insulated wire/insulated cable, as well as an insulated wire and an insulated cable using the fluorine-including elastomer composition.

### BRIEF DESCRIPTION OF THE DRAWINGS

Next, the present invention will be explained in more detail in conjunction with appended drawings, wherein:

FIG. 1 is a schematic cross sectional view showing an insulated cable in an embodiment of the present invention (an insulated cable provided with one or more insulated wires, each composed of a conductor and an insulation layer, and a sheath formed by providing a predetermined fluorine-including elastomer composition so as to cover an outer peripheral side of the one or more insulated wires and then crosslinking the fluorine-including elastomer composition); and

FIG. 2 is a schematic cross sectional view showing an insulated wire in the embodiment of the invention (an insulated wire provided with a conductor and an insulation layer formed by providing a predetermined fluorine-including elastomer composition so as to cover an outer periphery of the conductor and then crosslinking the fluorine-including elastomer composition).

### DETAILED DESCRIPTION OF THE PREFERRED EMBODIMENTS

### Summary Of Embodiments

A fluorine-including elastomer composition in the present embodiment includes a fluororesin component including a copolymer of tetrafluoroethylene and a-olefin having a carbon number of 2 to 4 (first fluorine-including copolymer) and an ethylene-tetrafluoroethylene copolymer (second fluorine-including copolymer), a polyethylene resin mixed in an amount of 10 to 50 parts by mass per 100 parts by mass of the fluororesin component, and a crosslinking aid.

An insulated wire in the present embodiment is provided with a conductor and an insulation layer formed by providing the above-mentioned fluorine-including elastomer composition so as to cover an outer periphery of the conductor and then crosslinking the fluorine-including elastomer composition.

Furthermore, an insulated cable in the present embodiment is provided with one or more insulated wires, each composed of a conductor and an insulation layer, and a sheath formed by providing the above-mentioned fluorine-including elastomer composition so as to cover an outer peripheral side of the one or more insulated wires and then crosslinking the fluorine-including elastomer composition.

### Embodiment

An embodiment of a fluorine-including elastomer composition of the invention and an insulated wire and an insulated cable using the same will be specifically described below in reference to the drawings.

I. Fluorine-Including Elastomer Composition

The fluorine-including elastomer composition in the present embodiment includes a fluororesin component including a copolymer of tetrafluoroethylene and a-olefin having a carbon number of 2 to 4 (first fluorine-including copolymer) and an ethylene-tetrafluoroethylene copolymer (second fluorine-including copolymer), a polyethylene resin and a crosslinking aid. Each component will be specifically described below.

1. Fluororesin Component

The fluororesin component used for the fluorine-including elastomer composition in the present embodiment includes a copolymer of tetrafluoroethylene and α-olefin having a carbon number of 2 to 4 (first fluorine-including copolymer) and an ethylene-tetrafluoroethylene copolymer (second fluorine-including copolymer).

(1-1) Copolymer of Tetrafluoroethylene and α-Olefin Having a Carbon Number of 2 to 4 (First Fluorine-Including Copolymer)

In the copolymer of tetrafluoroethylene and a-olefin having a carbon number of 2 to 4 (first fluorine-including copolymer) used in the present embodiment, an a-olefin having a carbon number of 2 to 4 which exhibits elastomeric properties by being copolymerized with tetrafluoroethylene may be propylene or butene-1 used alone or a combination of two or more selected from ethylene, propylene, butene-1 and isobutene, but is exemplarily propylene in order to achieve the object of the invention.

The copolymer of tetrafluoroethylene and a-olefin having a carbon number of 2 to 4, e.g., a tetrafluoroethylene-propylene copolymer, consists mainly of tetrafluoroethylene and propylene and may additionally and appropriately include components copolymerizable therewith, such as ethylene, isobutylene, acrylic acid and alkyl ester thereof, vinyl fluoride, vinylidene fluoride, hexafluoropropene, chloroethyl vinyl ether, chlorotrifluoroethylene and perfluoroalkyl vinyl ether.

In the copolymer of tetrafluoroethylene and a-olefin having a carbon number of 2 to 4, e.g., in a tetrafluoroethylene-propylene copolymer, a molar ratio of tetrafluoroethylene to propylene (tetrafluoroethylene/propylene) is preferably 95/5 to 30/70, more preferably 90/10 to 45/55 from the viewpoint of heat resistance and moldability, etc. In addition, the content of appropriately added components other than the main components is preferably not more than 50 mole %, more preferably, not more than 30 mole %.

(1-2) Ethylene-Tetrafluoroethylene Copolymer (Second Fluorine-Including Copolymer)

In the ethylene-tetrafluoroethylene copolymer (second fluorine-including copolymer), fluoroolefin may be used as a third component in addition to ethylene and tetrafluoroethylene. Examples of fluoroolefin include chlorotrifluoroethylene, vinylidene fluoride, trifluoroethylene, 1,1-dihydro perfluoropropene, 1,1-dihydro perfluorobutene-1, 1,5-trihydro-perfluoropentene-1, 1,7-trihydro-perfluoropentene-1, 1,1,2-trihydro perfluorohexene-1, 1,1,2-trihydro perfluorooctene-1, perfluoro(methyl vinyl ether), perfluoro(ethyl vinyl ether), hexafluoropropane, perfluorobutene-1 and 3,3,3-trifluoro-2-trifluoromethyl propene-1, etc.

A mass ratio of the copolymer of tetrafluoroethylene and a-olefin having a carbon number of 2 to 4 (first fluorine-including copolymer) to the ethylene-tetrafluoroethylene copolymer (second fluorine-including copolymer) in the mixture (the first fluorine-including copolymer: the second fluorine-including copolymer) is preferably 90:10 to 10:90. Tensile strength may not be improved when the ethylene-tetrafluoroethylene copolymer is less than 10 parts by mass while elongation may decreases when more than 90 parts by mass.

2. Polyethylene Resin

In the present embodiment, a polyethylene resin which is a cheap material is blended to expensive fluorine-based materials such as the copolymer of tetrafluoroethylene and a-olefin having a carbon number of 2 to 4 (first fluorine-including copolymer) and the ethylene-tetrafluoroethylene copolymer (second fluorine-including copolymer) for the purpose of suppressing foam or lump generation at the time of extrusion process as well as reducing the cost of compound.

There are various types of polyethylene from low density to high density and any type can be used. The required amount of polyethylene to be mixed is 10 to 50 parts by mass per 100 parts by mass of the fluororesin component (the copolymer of tetrafluoroethylene and a-olefin having a carbon number of 2 to 4 and the ethylene-tetrafluoroethylene copolymer). An effect of suppressing foam or lump generation at the time of extrusion process is not obtained when less than 10 parts by mass while cut-through resistance at high temperature decreases when more than 50 parts by mass. The cut-through resistance is an index indicating toughness of electric wire and is tested by a method in which an electric wire is placed on a 90-degree metal edge and a predetermined load is applied to the electric wire. To pass this test, the edge and the conductor should not be electrically conducted for a predetermined time.

The reason why foam or lump generation at the time of extrusion process is suppressed by mixing polyethylene is presumed that a portion of polyethylene dissolved in the fluororesin component perturbs crystallinity of the fluororesin component, the fluororesin component thus becomes likely to melt and self-heating during extrusion is thereby suppressed.

Among polypropylene, ethylene-vinyl acetate copolymer and ethylene-acrylic ester copolymer, etc., which are listed as the cheap material, polypropylene is broken down without causing crosslinking when exposed to radiation and thus cannot be used. Meanwhile, ethylene-vinyl acetate copolymer, ethylene-acrylic ester copolymer and ethylene-a-olefin copolymer, etc., are not suitable for the invention due to higher cost and poorer toughness than polyethylene but can be used if necessary. Alternatively, polymers obtained by modifying these materials with maleic acid, etc., may be used.

3. Crosslinking Aid

In the present embodiment, a crosslinking aid is mixed in order to increase cross-linking reactivity. An allylic compound such as triallylisocyanurate, triallylcyanurate, triallyltrimellitate, tetraallylpyromellitate, etc., is particularly exemplary as the crosslinking aid.

4. Other Components to be Mixed

In the present embodiment, various components such as another inorganic filler (e.g., calcium carbonate), a stabilizer, an antioxidant, a plasticizer and a lubricant can be mixed in addition to the above-mentioned components.

II. Insulated Wire

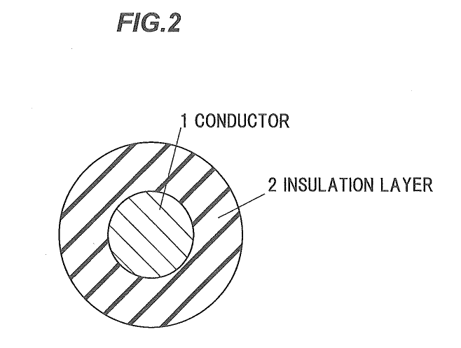

As shown in FIG. 2, the insulated wire in the present embodiment is composed of a conductor 1 formed of, e.g., a widely-used copper twisted wire and an insulation layer 2 formed by providing the above-mentioned fluorine-including elastomer composition so as to cover an outer periphery of the conductor 1 and then crosslinking the fluorine-including elastomer composition.

III. Insulated Cable

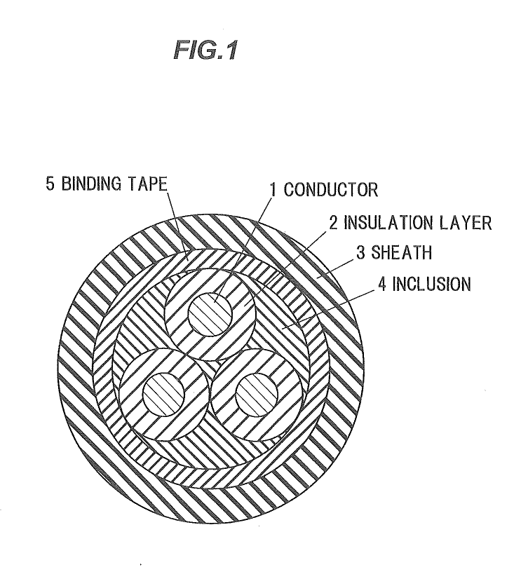

As shown in FIG. 1, the insulated cable in the present embodiment is composed of one or more insulated wires each composed of the conductor 1 and the insulation layer 2, a holding member, e.g., a binding tape 5, which is wound together with, e.g., a paper inclusion 4 on an outer peripheral side of the one or more insulated wires, and a sheath 3 formed by providing the above-mentioned fluorine-including elastomer composition so as to cover an outer periphery of the binding tape 5 and then crosslinking the fluorine-including elastomer composition. In this case, it is preferable that the insulation layer 2 be formed of the above-mentioned fluorine-including elastomer composition.

### EXAMPLES

The fluorine-including elastomer composition of the invention and the insulated wire and the insulated cable using the same will be described more specifically below in reference to Examples. It should be noted that the following Examples are not intended to limit the invention in any way.

### Example 1

### Components to be Mixed

The following components were mixed. The mixed amounts thereof were as described below (see Table 1).
90 parts by mass of tetrafluoroethylene-propylene copolymer (trade name: AFLAS 150E, manufactured by Asahi Glass Co., Ltd.) as the copolymer of tetrafluoroethylene and α-olefin having a carbon number of 2 to 4 (first fluorine-including copolymer) constituting the fluororesin component
10 parts by mass of ethylene-tetrafluoroethylene copolymer (trade name: Fluon ETFE LM-730A, manufactured by Asahi Glass Co., Ltd.) as the second fluorine-including copolymer constituting the fluororesin component
10 parts by mass of polyethylene (trade name: EXCELLEN FX CX-2001, manufactured by Sumitomo Chemical Co., Ltd.) as the polyethylene resin
1 part by mass of allylic compound (triallylisocyanurate) as the crosslinking aid
50 parts by mass of calcium carbonate as a filler

### Making of Rubber Compound

The components listed above were dissolved and kneaded with a kneader, thereby making a rubber compound.

### Manufacture of Insulated Wire

Next, using a 40-mm extruder (L/D=22, temperature of a cylinder 1 was set to 200° C., a cylinder 2 set to 260° C., a die set to 270° C. and a head set to 280° C.), the compound was extruded to 0.4 mm thickness on a tin-plated copper twisted conductor having an outer diameter of 0.9 mm to form a cover layer which was subsequently crosslinked by exposure to 10 Mrad of electron beam, thereby making an insulated wire.

Table 1 lists the mixed components of the fluorine-including elastomer composition used in Example 1 and below-described evaluation results of insulated wires.

### Examples 2 to 8

Insulated wires in Examples 2 to 8 were made in the same manner as Example 1 except that the amounts of the components mixed in the fluorine-including elastomer composition were changed to those shown in Table 1. The evaluation results of the wires are shown in Table 1.

### Comparative Examples 1 to 4

Insulated wires in Comparative Examples 1 to 4 were made in the same manner as Example 1 except that the amounts of the components mixed in the fluorine-including elastomer composition were changed to those shown in Table 1. The evaluation results of the wires are shown in Table 1.

### Wire Evaluation Method

The tin-plated copper twisted wire was pulled out of each insulated wire manufactured as described above to obtain a tube-shaped sample. The insulated wires were evaluated by measuring tensile strength and elongation of each sample as well as measuring cut-through resistance in the form of wire.

Not less than 15 MPa of tensile strength and not less than 150% of elongation were respectively regarded as “passed the test”. Meanwhile, a wire was placed on a 90-degree metal edge and a load of 350 g was applied thereto at 180° C., and no electrical conduction between the edge and the conductor for 10 minutes was regarded as “passed” the test of cut-through resistance.

All of Examples 1 to 8 which fall within the range of the invention were excellent in processability (with good appearance after extrusion and without foam or lump generation) and passed the tests of all characteristics (tensile strength, elongation and cut-through properties).

Comparative Example 1, in which the mixed amount of the polyethylene resin is less than the range of the invention, had a poor appearance after extrusion with foam or lump generation and was insufficient in tensile strength and elongation.

Comparative Example 2, in which the mixed amount of the polyethylene resin is more than the range of the invention, was insufficient in cut-through resistance.

Comparative Example 3, in which the mixed amount of the polyethylene resin is less than the range of the invention, had a poor appearance after extrusion with foam or lump generation and was insufficient in elongation.

Comparative Example 4, in which the mass ratio of the first fluorine-including copolymer to the second fluorine-including copolymer in the mixture is 95:5, was insufficient in tensile strength and failed in cut-through resistance.

TABLE 1
(Unit of mixed component: parts by mass)

| | | | Examples | | | | | | | |
|---|---|---|---|---|---|---|---|---|---|---|
| Items | | Samples | 1 | 2 | 3 | 4 | 5 | 6 | 7 | 8 |
| Components | Fluororesin | Tetrafluoroethylene-propylene copolymer ¹⁾ | 90 | 90 | 90 | 70 | 40 | 10 | 10 | 10 |
| | component | Ethylene-tetrafluoroethylene copolymer ²⁾ | 10 | 10 | 10 | 30 | 60 | 90 | 90 | 90 |
| | Polyethylene resin ³⁾ | | 10 | 30 | 50 | 30 | 30 | 10 | 30 | 50 |
| | Crosslinking aid | Allylic compound ⁴⁾ | 1 | 1 | 1 | 1 | 1 | 1 | 1 | 1 |
| | Filler | Calcium carbonate | 50 | 50 | 50 | 50 | 50 | 50 | 50 | 50 |
| Evaluation | Processability | Appearance after extrusion | Good | Good | Good | Good | Good | Good | Good | Good |
| | | Foam or lump generation | no | no | no | no | no | no | no | no |
| | Toughness | Tensile strength (MPa): target-not less than 15 | 15.4 | 16.0 | 17.3 | 18.2 | 21.1 | 23.5 | 24.0 | 25.6 |
| | | Elongation (%): target-not less than 150 | 250 | 270 | 310 | 300 | 240 | 160 | 170 | 210 |
| | | Cut-through resistance: 350 g at 180° C. | Pass | Pass | Pass | Pass | Pass | Pass | Pass | Pass |

| | | | Comparative Examples | | | |
|---|---|---|---|---|---|---|
| Items | | Samples | 1 | 2 | 3 | 4 |
| Components | Fluororesin | Tetrafluoroethylene-propylene copolymer ¹⁾ | 90 | 90 | 70 | 95 |
| | component | Ethylene-tetrafluoroethylene copolymer ²⁾ | 10 | 10 | 30 | 5 |
| | Polyethylene resin ³⁾ | | 5 | 55 | 5 | 10 |
| | Crosslinking aid | Allylic compound ⁴⁾ | 1 | 1 | 1 | 1 |
| | Filler | Calcium carbonate | 50 | 50 | 50 | 50 |
| Evaluation | Processability | Appearance after extrusion | Poor | Good | Poor | Good |
| | | Foam or lump generation | found | no | found | no |
| | Toughness | Tensile strength (MPa): target-not less than 15 | 13.2 | 17.5 | 15.5 | 12.6 |
| | | Elongation (%): target-not less than 150 | 120 | 310 | 140 | 270 |
| | | Cut-through resistance: 350 g at 180° C. | Pass | Fail | Pass | Fail |

¹⁾ Tetrafluoroethylene-propylene copolymer: AFLAS 150E from Asahi Glass
²⁾ Ethylene-tetrafluoroethylene copolymer: Fluon ETFE LM-730A from Asahi Glass
³⁾ Polyethylene: EXCELLEN FX CX-2001 from Sumitomo Chemical
⁴⁾ Allylic compound: triallylisocyanurate

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A fluorine-including elastomer composition, comprising:
a fluororesin component comprising a first fluorine-including copolymer comprising a tetrafluoroethylene and an a-olefin having a carbon number of 2 to 4 and a second fluorine-including copolymer comprising an ethylene-tetrafluoroethylene copolymer;
a polyethylene resin mixed in an amount of 10 to 50 parts by mass per 100 parts by mass of the fluororesin component; and
a crosslinking aid,
wherein a mass ratio of the first fluorine-including copolymer to the second fluorine-including copolymer is 90:10 to 10:90.

2. An insulated wire, comprising:
a conductor; and
an insulation layer formed on an outer periphery of the conductor by covering the conductor with the fluorine-including elastomer composition according to claim 1 and crosslinking the fluorine-including elastomer composition.

3. An insulated cable, comprising:
one or more insulated wires each comprising a conductor and an insulation layer; and
a sheath formed on an outer periphery of the one or more insulated wires by covering the sheath with the fluorine-including elastomer composition according to claim 1 and crosslinking the fluorine-including elastomer composition.
